(19) United States
(12) Patent Application Publication
(10) Pub. No.: US 2017/0062095 A1
(43) Pub. Date: Mar. 2, 2017

(54) COAXIAL CABLE WITH LOWER STRESS OUTER CONDUCTOR

(71) Applicant: CommScope Technologies LLC, Hickory, NC (US)

(72) Inventor: Alan N. Moe, Hickory, NC (US)

(21) Appl. No.: 15/254,596

(22) Filed: Sep. 1, 2016

Related U.S. Application Data
(60) Provisional application No. 62/213,367, filed on Sep. 2, 2015.

(51) Int. Cl. H01B 11/18

(52) U.S. Cl. CPC H01B 11/1808

(57) ABSTRACT

A coaxial cable includes: an inner conductor; a dielectric layer surrounding the inner conductor; and an outer conductor having a plurality of corrugations. Each of the corrugations has a root and a crest connected by a transition section. The root has a first radius of curvature, the crest has a second radius of curvature, and the ratio of the first radius of curvature to the second radius of curvature is equal to or greater than 1.

### RELATED APPLICATION

The present application claims priority from and the benefit of U.S. Provisional Patent Application No. 62/213,367, filed Sep. 2, 2015, the disclosure of which is hereby incorporated herein in its entirety.

### FIELD OF THE INVENTION

The present invention is directed generally to coaxial cable, and more particularly to outer conductors for coaxial cable.

### BACKGROUND

Coaxial cable typically includes an inner conductor, an outer conductor, a dielectric layer that separates the inner and outer conductors, and a jacket that surrounds the outer conductor. The outer conductor can take many forms, including flat, braided, and corrugated.

A typical corrugated cable outer conductor is manufactured by welding a thin wall cylindrical tube from a flat copper strip. This tube is then formed into a corrugated outer conductor with a specific shape by using use of one of several available forming methods. A typical shape for an outer conductor of a corrugated cable is shown in FIG. 1.

As can be seen in FIG. 1, the outer/major diameter, or crest 12, of the corrugations of the outer conductor 10 has a relatively gentle curvature (i.e., the radius of curvature RC is relatively large), whereas the inner/minor diameter, or root 14, of the corrugations has a relatively sharp curvature (i.e., the radius of curvature RR is relatively small). This shape is formed using a forming tool operating at the root 14 of the corrugation.

Because copper is costly and because the function of an outer conductor is primarily for shielding, a thin copper (0.002″ thick) would perform the electrical shielding function adequately. However, the thickness of the outer conductor 10 is typically greater than 0.006″ due to manufacturing and mechanical limitations (particularly for reliable welding of the seam).

While the illustrated corrugation shape results in a cable with adequate bending performance, it may be desirable to further improve on the design and to further reduce the copper content of the cable, without further reduction of copper thickness, and also without sacrificing cable bending performance.

### SUMMARY

As a first aspect, embodiments of the invention are directed to a coaxial cable, comprising: an inner conductor; a dielectric layer surrounding the inner conductor; and an outer conductor having a plurality of corrugations. Each of the corrugations has a root and a crest connected by a transition section. The root has a first radius of curvature, the crest has a second radius of curvature, and the ratio of the first radius of curvature to the second radius of curvature is equal to or greater than 1.

As a second aspect, embodiments of the invention are directed to a coaxial cable, comprising: an inner conductor; a dielectric layer surrounding the inner conductor; and an outer conductor having a plurality of corrugations. Each of the corrugations has a root and a crest connected by a transition section. The transition section is concave.

As a third aspect, embodiments of the invention are directed to a coaxial cable, comprising: an inner conductor; a dielectric layer surrounding the inner conductor; and an outer conductor having a plurality of corrugations. Each of the corrugations has a root and a crest connected by a transition section. The transition section is substantially straight.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 is a side view of a portion of a corrugated outer conductor for a conventional coaxial cable.

FIG. 2 is a side view of a portion of a corrugated outer conductor for a coaxial cable according to embodiments of the invention.

FIG. 2a is an enlarged side view of a portion of a corrugation of the outer conductor of FIG. 2.

FIG. 3 is a side view of a portion of a corrugated outer conductor for a coaxial cable according to alternative embodiments of the invention.

FIG. 3a is an enlarged side view of a portion of a corrugation of the outer conductor of FIG. 3.

FIG. 4 is a side section view of a portion of a corrugated outer conductor for a coaxial cable according to further embodiments of the invention.

FIG. 5 is an enlarged side section view of a portion of a corrugation of the outer conductor of FIG. 4.

FIG. 6 is a side section view of a portion of a corrugated outer conductor for a coaxial cable according to yet further embodiments of the invention.

FIG. 7 is a side section view of a portion of a corrugated outer conductor for a coaxial cable according to still further embodiments of the invention.

FIG. 8 is a side section view and an enlarged partial side section view of a corrugated outer conductor according to further embodiments of the invention.

FIG. 9 is a three-dimensional plot of stress induced by simulated bending of the outer conductor of FIG. 8.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

As discussed above, the material thickness of the outer conductor is largely determined based on manufacturing needs. When designing a cable, the inner and outer diameters of the corrugations of the outer conductor can be set to different values, which will have an effect upon the electrical and mechanical performance of the cable. However, given fixed corrugation major and minor diameters (the difference of which is the “depth” of the corrugation), pitch (i.e., the length between each corrugation) and copper thickness, the shape of the corrugation can beneficially impact the mechanical properties and cost of a coaxial cable. As examples, a typical corrugation depth for a ½ inch cable is between about 0.044 and 0.066 inches, and a typical corrugation pitch is between about 0.110 and 0.200 inches.

As discussed above, in cross-section the typical annular corrugated design has a small U-shaped arc RR in the root 14, defining the minor diameter, followed by a larger arc RC forming the major diameter at the crest 12. This is a convenient shape (see FIG. 1) because it enables a relatively simple shape and design of the manufacturing tools.

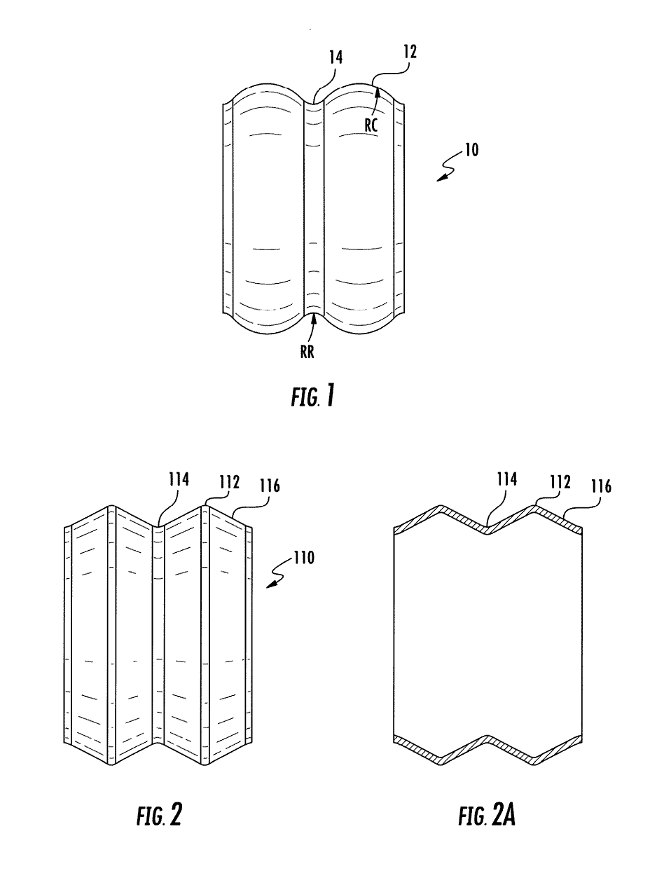

Referring now to FIG. 2, an outer conductor 110 is illustrated that replaces the large arched shape of the crest 12 with a design that makes more use of a straight line corrugation in the transition section 116 between the root 114 and the crest 112. This modification can reduce the weight of the outer conductor 110 (in the case of an LDF-4 cable, available from CommScope, Hickory, N.C., the reduction is ˜3.8%), while preserving the depth to pitch ratio of the prior corrugation.

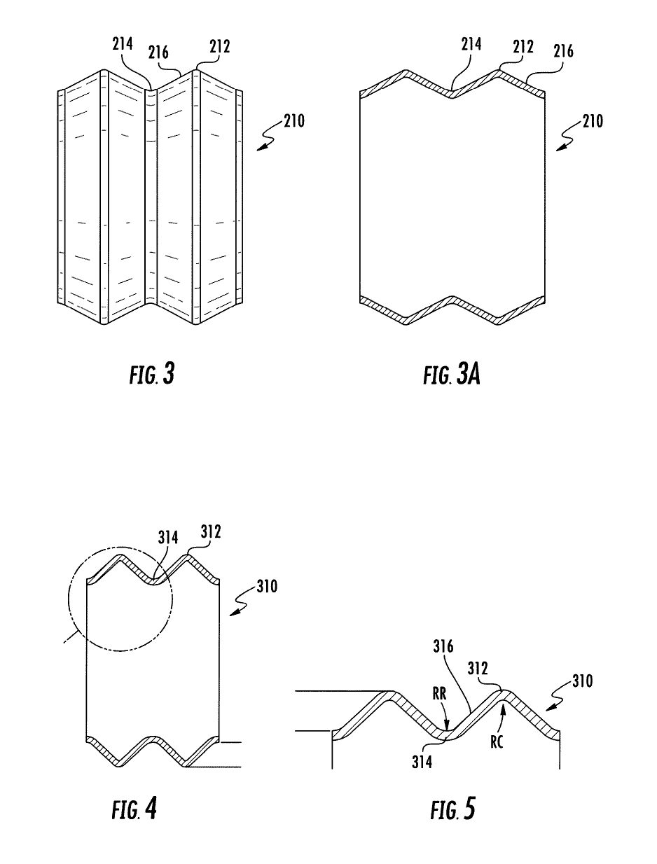

FIG. 3 illustrates another embodiment of an outer conductor 210 intended to reduce copper usage. A weight optimized shape of a shell of revolution that connects two points at an angle is not a straight line, but a slightly curved line with a longer two-dimensional path length that creates a slightly concave surface between the crest 212 and the root 214. By using this type of curved concave path in the transition section 216, the design weight can be reduced further.

The difference between the conductor 110 of FIG. 2 and the conductor 210 of FIG. 3 is illustrated in the enlarged views of FIGS. 2a and 3a, respectively. The concave bowing inward of the transition section 216 depicted in FIG. 3a (˜0.005″ deep) results in a longer 2-dimensional path length in the x-y plane (i.e., between the crest 212 and the root 214), but also a 0.4% lower net weight of the outer conductor 210 with an identical major diameter, minor diameter and pitch.

Examination of failures in corrugated cables with designs similar to those shown in FIG. 1 reveals that a critical limitation of the cable performance is the repeated bending performance and that metal fatigue failure occurs in the root of the corrugation. Typically, a cable designer, when faced with inadequate reverse bending performance in a cable design, would improve the reverse bending performance of the cable by reducing the rotational strain level experienced in the root of the corrugation by increasing the depth of the corrugation, while holding the pitch constant, or by also reducing the pitch. This modification will increase the amount of copper in the outer conductor (and therefore the cost) of the design.

In a corrugation in which the root diameter RR is relatively small and the crest diameter RC is relatively large (such as the conductor 10 of FIG. 1), the stress concentration factor associated with the small root diameter RR properly predicts higher stresses in the root 14 during cable bending, while the lower stress concentration factor associated with the gentle, more generous arc RC in the crest 12 suggest that lower stresses will appear in the crest 12 during the same overall cable bending curvature level. The volume of the copper per unit cable length is far greater in the crest 12 than in the root 14, due to the greater diameter at the crest 12. As a result, less copper is available in the root area to absorb the fatigue damage than is available in the crest area. By re-designing the shape of the corrugation, it is possible to reduce the stress at the root and intentionally shift more of the deformation and stress to the crest, where it can be better absorbed by this greater volume of material available there.

FIGS. 4 and 5 illustrate corrugations of an outer conductor 310 according to additional embodiments that includes equal radii RC, RR for the crest 312 and the root 314. The outer conductor 310 also has a straight, lower cost transition section 316 such as that depicted above in FIG. 2, but it should be understood that this area could be altered by designing in the lower cost concave outward bowed shape shown in in FIGS. 3 and 3a. The design of FIGS. 4 and 5, with a larger root radius and a smaller radius crest will weigh less and perform better in fatigue than would a typical shaped as shown in FIG. 1 at the same corrugation and depth. This is due to the larger radius in use at the root of this design, which has been found to result in lower stresses at the root when using the same depth and pitch. Because of the greater weight efficiency in the transition section the copper usage in this design is lower than for the design of FIG. 1. In such an embodiment, RR and RC may be between about 0.020 and 0.100 inches.

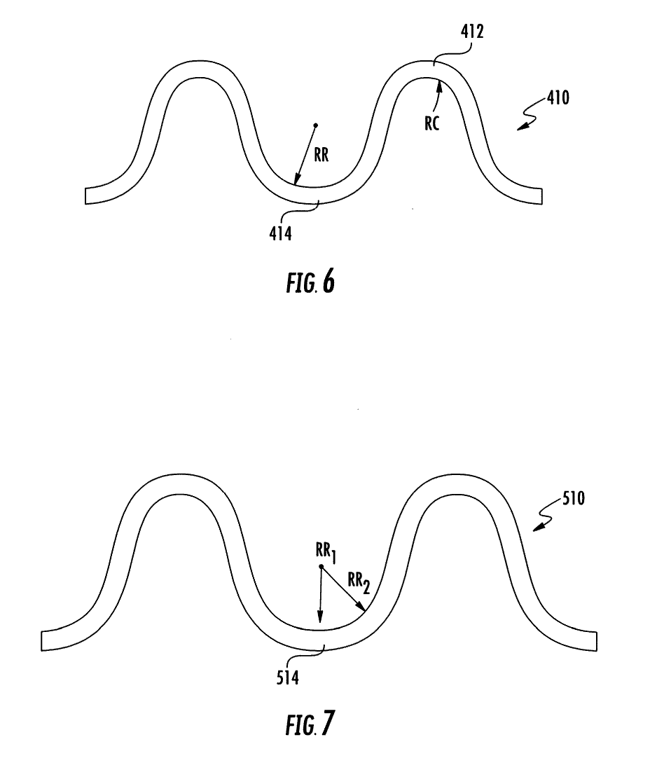

FIG. 6 illustrates an outer conductor 410 similar to conductor 310 above, but which has a larger radius RR for the root 414 than the radius RC for the crest 412, i.e., the ratio of RR to RC is greater than 1. Typical dimensions for RR may be between about 0.030 and 0.038 inches, and for RC may be between about 0.022 and 0.026 inches. This design will more nearly result in optimum fatigue performance of the outer conductor for a given corrugation pitch and depth. After the fatigue performance is increased in this manner, the corrugation depth of the outer conductor 410 can be reduced, thereby reducing the amount of copper in the outer conductor.

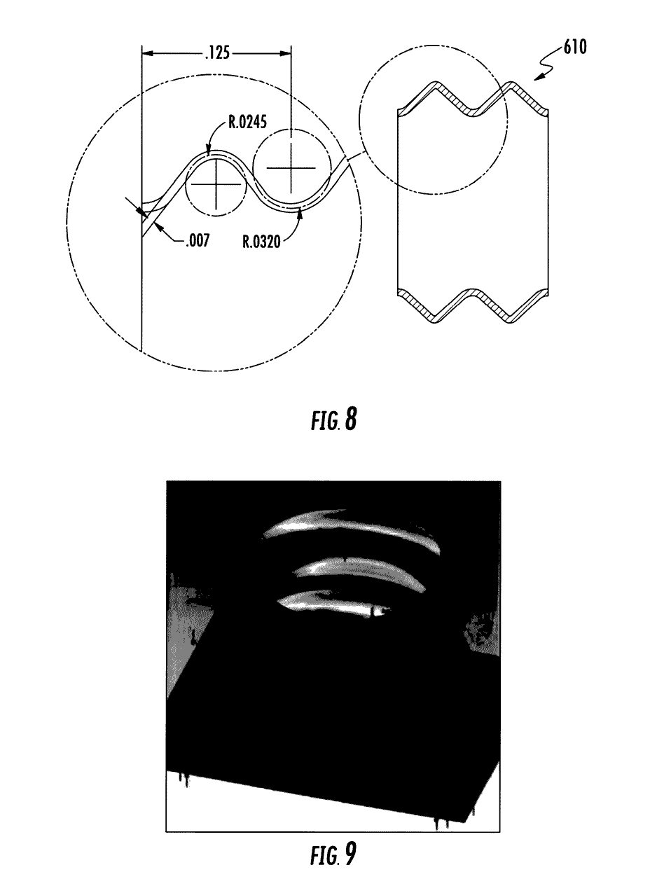

FIG. 7 illustrates an outer conductor 510 with a more complex shape that may much more evenly distribute the stress in the structure during bending and can provide a more favorable shape for improving the adhesive bonding performance to the underlying dielectric foam structure. This design has a root 514 with a flatter bottom to the root (as demonstrated by RR₂ at the center of the root 514 being larger than RR₁ toward the side of the root 514). While the effective electrical diameter of this design may be somewhat reduced (due to the increased length of the root of the corrugations), after adjusting the overall diameter slightly to maintain attenuation, in addition to reduced stress at the root 514, the cost may be lower due to the reduced depth to pitch ratio.

Embodiments of the invention are further illustrated in the following, non-limiting example.

FIG. 8 illustrates a theoretical corrugated outer conductor 610 formed of copper 0.007 inch in thickness that has a root radius of 0.032 inch and a crest radii of 0.0245 inch (the radii of the root and crest are measured to the center of the thickness of the conductor). The corrugations are 0.125 inch from crest to crest. When the conductor 610 is placed under a simulated bending moment, the resulting stress patterns is shown in FIG. 9. As can be seen from FIG. 9, the stresses in the root and crest are more nearly equal, resulting in an overall stress reduction at the root area as compared with prior designs in which the root radius is smaller than the crest radius. Thus, this configuration can address prior bending fatigue failures at the root seen in prior outer conductors.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial cable, comprising:
an inner conductor;
a dielectric layer surrounding the inner conductor; and
an outer conductor having a plurality of corrugations;
wherein each of the corrugations has a root and a crest connected by a transition section, and wherein the root has a first radius of curvature, the crest has a second radius of curvature, and the ratio of the first radius of curvature to the second radius of curvature is equal to or greater than 1.

2. The coaxial cable defined in claim 1, wherein the ratio of the first radius of curvature to the second radius of curvature is greater than 1.

3. The coaxial cable defined in claim 1, wherein the transition section is substantially straight.

4. The coaxial cable defined in claim 1, wherein the transition section is concave.

5. The coaxial cable defined in claim 1, wherein the root is generally flattened.

6. The coaxial cable defined in claim 1, wherein the first radius is between about 0.030 and 0.038 inches, and the second radius is between about 0.022 and 0.026 inches.

7. A coaxial cable, comprising:
an inner conductor;
a dielectric layer surrounding the inner conductor; and
an outer conductor having a plurality of corrugations;
wherein each of the corrugations has a root and a crest connected by a transition section, and wherein the transition section is concave.

8. The coaxial cable defined in claim 7, wherein the root has a first radius of curvature, the crest has a second radius of curvature, and the ratio of the first radius of curvature to the second radius of curvature is greater than 1.

9. The coaxial cable defined in claim 7, wherein root of the corrugation is generally flattened.

10. The coaxial cable defined in claim 8, wherein the first radius is between about 0.030 and 0.038 inches, and the second radius is between about 0.022 and 0.026 inches.

11. A coaxial cable, comprising:
an inner conductor;
a dielectric layer surrounding the inner conductor; and
an outer conductor having a plurality of corrugations;
wherein each of the corrugations has a root and a crest connected by a transition section, and wherein the transition section is substantially straight.

12. The coaxial cable defined in claim 11, wherein the root has a first radius of curvature, the crest has a second radius of curvature, and the ratio of the first radius of curvature to the second radius of curvature is greater than 1.

13. The coaxial cable defined in claim 11, wherein root of the corrugation is generally flattened.

14. The coaxial cable defined in claim 12, wherein the first radius is between about 0.030 and 0.038 inches, and the second radius is between about 0.022 and 0.026 inches.
